(19) United States
(12) Patent Application Publication
(10) Pub. No.: US 2018/0152411 A1
(43) Pub. Date: May 31, 2018

(54) METHOD FOR PROVIDING CHAT SERVICE USING CLIENT BOT AND APPARATUS FOR PERFORMING SAME

(71) Applicant: KAKAO CORP., Jeju-si Jeju-do (KR)

(72) Inventors: Kyoung Won LEE, Seoul (KR); Hyun Ji LEE, Seoul (KR); Eun Jung KO, Seoul (KR)

(21) Appl. No.: 15/570,544

(22) PCT Filed: Apr. 15, 2016
(86) PCT No.: PCT/KR2016/003918

§ 371 Date: Oct. 30, 2017

(30) Foreign Application Priority Data
Apr. 30, 2015 (KR) 10-2015-0061679

(51) Int. Cl. H04L 12/58; H04L 29/06; H04L 29/08

(52) U.S. Cl. CPC H04L 51/32; H04L 51/02; H04L 65/1073; H04L 65/1093; H04L 67/306; H04L 51/046

(57) ABSTRACT

Disclosed is a method for providing a chat service using a client bot and an apparatus for performing the method. The method for providing a chat service may comprise the steps of: transferring, to a server, input data input into a chat room in which a client bot of a specific group participates; receiving, from the server, group data for the specific group that are processed by the client bot according to the input data; and displaying the received group data.

### TECHNICAL FIELD

Embodiments of the present invention relate to a method of providing a chat service and an apparatus for performing the method, and more particularly, to a method and apparatus for providing a chat service using a client bot registered as a friend in response to joining a specific group.

### BACKGROUND ART

Recently, a specific organization or group such as a company provides a chat service to enable group members to exchange necessary information. As described above, by providing the chat service to enables the group members to easily exchange information, a work efficiency may improve or information to be transferred may be conveniently transferred in real time in a group or an organization.

However, many existing friend lists include only group members of a group or an organization. Since a chat service is performed only between general group members, it is difficult to inquire of an appropriate person about information related to the group or the organization to acquire the information in reality.

In addition, although a group member to inquire of is known in reality, an unnecessary chat with the group member may be needed to acquire the necessary information, and thus a great time and effort may be required to acquire the necessary information.

Accordingly, a scheme of enabling group members of a specific group or organization to acquire information related to the group or organization more easily is needed.

### DISCLOSURE OF INVENTION

### Technical Goals

An aspect of the present invention provides a method and apparatus that may rapidly and conveniently acquire content related to a specific group by registering a client bot related to the specific group as a virtual friend and transferring input data to the client bot in a chat window.

Another aspect of the present invention provides a method and apparatus that may enable a group member to conveniently access content related to a specific group by automatically registering a client bot as a virtual friend of group members in response to joining the specific group.

Still another aspect of the present invention provides a method and apparatus that may improve a chat efficiency between group members of a specific group by inviting a group member to chat with as a chat user through a client bot, without a need of registering all group members belonging to the specific group as friends.

### Technical Solutions

According to an aspect of the present invention, there is provided a method of providing a chat service, the method performed by a user terminal, the method including transferring input data related to a specific group to a server, the input data input into a chat room in which a client bot interoperating with the specific group participates, receiving group data corresponding to the input data from the server, and displaying the received group data. The specific group may be formed in the chat service or in an external service of the chat service, and the server may be configured to operate a service related to the specific group and transfer the group data to the user terminal through the client bot.

The chat room may be created when a user of the user terminal selects the client bot, or invites the client bot or a friend of the user terminal.

The method may further include determining whether the user terminal joins the specific group when the chat room is created, and transferring a join request with respect to the specific group when the user terminal does not join the specific group.

The client bot may be automatically or manually set as a friend of the user terminal in response to the user terminal joining the specific group.

The client bot may be set as a friend of the user terminal based on information related to the specific group or information related to the user terminal when the user terminal joins the specific group.

The client bot may be set as a friend of the user terminal when in response to the user terminal selecting a client bot registered as a virtual friend or using an official account when the user terminal joins the specific group.

The input data may include based at least one word to acquire the group data related to the specific group.

The displaying of the received group data in the chat room may include displaying organization information or group member information of the specific group related to the client bot.

According to another aspect of the present invention, there is also provided a method of providing a chat service, the method performed by a server, the method including receiving, from a user terminal, input data input into a chat room in which a client bot of a specific group participates, the user terminal joining the specific group, acquiring group data related to the specific group that are processed by the client bot based on the input data, and providing the group data to the user terminal.

According to still another aspect of the present invention, there is also provided a user terminal including an input data transferor configured to transfer, to a server, input data input into a chat room in which a client bot of a specific group participates, a group data receiver configured to receive, from the server, group data related to the specific group that are processed by the client bot based on the input data, and a group data display configured to display the received group data.

### Effects

According to an embodiment, content related to a specific group may be rapidly and conveniently acquired by registering a client bot related to the specific group as a virtual friend and transferring input data to the client bot in a chat window.

According to an embodiment, a group member may be enabled to conveniently access content related to a specific group by automatically registering a client bot as a virtual friend of group members in response to joining the specific group.

According to an embodiment, a chat efficiency between group members of a specific group may be improved by inviting a group member to chat with as a chat user through a client bot, without a need of registering all group members belonging to the specific group as friends.

### BRIEF DESCRIPTION OF DRAWINGS

FIG. 1 is a diagram illustrating a relationship between users belonging to a specific group and a client bot according to an embodiment.

FIG. 2 is a diagram illustrating a method of providing a chat service using a client bot according to an embodiment.

FIG. 3 is a flowchart illustrating a method of providing a chat service according to an embodiment.

FIG. 4 is a diagram illustrating a chat window to perform a chat with a client bot selected in a friend list according to an embodiment.

FIG. 5 is a diagram illustrating a chat window to perform a chat with a client bot through a menu provided on a page of a specific group according to an embodiment.

FIG. 6 is a diagram illustrating a process of providing content related to a keyword in response to an input of a message generated by combining an instruction and the keyword according to an embodiment.

FIG. 7 is a diagram illustrating an example of acquiring personal information of a group member of a specific group according to an embodiment.

FIG. 8 is a diagram illustrating another example of acquiring personal information of a group member of a specific group according to an embodiment.

FIG. 9 is a diagram illustrating an example of acquiring group data related to a specific group according to an embodiment.

FIG. 10 is a diagram illustrating another example of acquiring group data related to a specific group according to an embodiment.

FIG. 11 is a diagram illustrating an example of indicating a position of a group member of a specific group according to an embodiment.

FIG. 12 is a diagram illustrating an example of displaying neighborhood information of a specific group according to an embodiment.

FIG. 13 is a diagram illustrating an example of displaying detailed information through neighborhood information of a specific group according to an embodiment.

FIG. 14 is a diagram illustrating an example of inviting a group member of a specific group as a chat user according to an embodiment.

FIG. 15 is a diagram illustrating another example of inviting a group member of a specific group as a chat user according to an embodiment.

FIG. 16 is a diagram illustrating still another example of inviting a group member of a specific group as a chat user according to an embodiment.

### BEST MODE FOR CARRYING OUT THE INVENTION

Hereinafter, reference will now be made in detail to embodiments of the present invention.

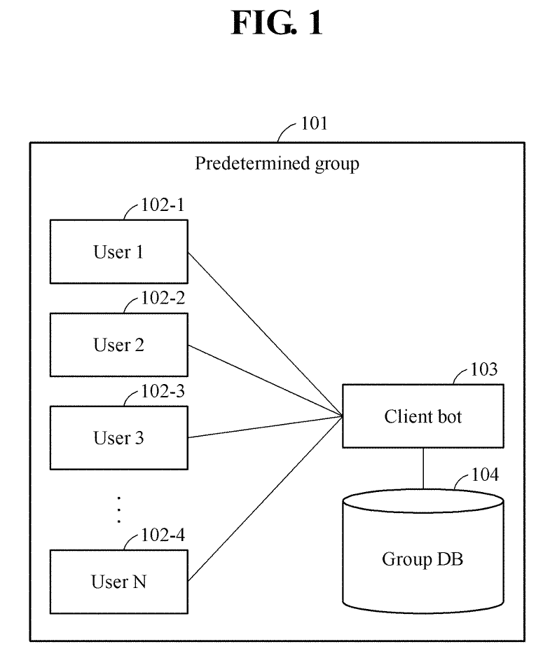

FIG. 1 is a diagram illustrating a relationship between users belonging to a specific group and a client bot according to an embodiment.

Referring to FIG. 1, a process in which a plurality of users 102-1 to 102-4 joining a specific group 101 acquires group data related to the specific group from a group database (DB) 104 through a client bot 103 is illustrated.

The client bot 103 may act as a gateway between the users 102-1 to 102-4 joining the specific group and the specific group. That is, in a case in which a specific group is created in a messenger used by the users 102-1 to 102-4, the plurality of users 102-1 to 102-4 may easily acquire group data related to the specific group through the client bot 103 in a chat room in which the client bot 103 participates.

The specific group 101 refers to a specific organization such as a company or an association. In this example, the specific group 101 may include a specific offline organization, and a specific online organization such as a café, a blog, or a club. The specific group 101 may be created in a chat service provided through a message application or in an external service (ex. a social network service (SNS)) of the chat service.

Here, the plurality of users 102-1 to 102-4 refers to group members joining the specific group 101. In particular, the specific group 101 may provide the chat service to the plurality of users 102-1 to 102-4 who are group members joining the specific group 101.

Although the plurality of users 102-1 to 102-4 do not join the specific group 101, the users 102-1 to 102-4 may be set as friends of the client bot 103 of the specific group 101. However, when entering the chat room together with the client bot 103, whether the plurality of users 102-1 to 102-4 joins the specific group 101 may be checked.

If the plurality of users 102-1 to 102-4 participates in the chat room without joining the specific group, a request to join the specific group 101 may be transferred to the plurality of users 102-1 to 102-4. The plurality of users 102-1 to 102-4 may need to join the specific group 101 to acquire the group data related to the specific group 101 in the chat room through a chat with the client bot 103 of the specific group 101.

In this example, the chat service may support a chat among the group members joining the specific group 101, and a chat between at least one group member and the client bot 103 to acquire the group data related to the specific group 101. Through the chat with the client bot 103, the group members joining the specific group 101 may acquire group data related to the specific group 101 stored in the group DB 104, or group data generated by the specific group 101.

For this, when the plurality of users 102-1 to 102-4 joins the specific group 101 which exists online or offline, the client bot 103 may need to be manually or automatically set as a friend of the plurality of users 102-1 to 102-4 who are the group members of the specific group 101.

Here, being automatically set as a friend refers to a case in which the client bot 103 is automatically set as a friend of the plurality of users 102-1 to 102-4 based on information related to the specific group 101 extracted from information related to the plurality of users 102-1 to 102-4 or information related to the specific group 101 being directly input although the plurality of users 102-1 to 102-4 installing the message application does not separately add the client bot 103 as a friend. Here, the information related to the specific group 101 may include a name, identification information (an ID, a unique number, etc.), an image (an icon, a sticker, a mark, etc.), or a link address of the specific group 101. The above description may apply to all cases in which the plurality of users 102-1 to 102-4 joins a specific offline or online group 101.

For example, in a case in which the plurality of users 102-1 to 102-4 each joins a specific offline group 101, the client bot 103 set for the specific group 101 may be registered as a friend of the plurality of users 102-1 to 102-4 based on information related to the specific group 101 that is directly input by each of the plurality of users 102-1 to 102-4.

In another example, in a case in which the plurality of users 102-1 to 102-4 each joins a specific offline group 101, the client bot 103 set for the specific group 101 may be registered as a friend of the plurality of users 102-1 to 102-4 based on information related to the plurality of users 102-1 to 102-4 joining the specific group 101 that is transferred or input by a manager of the specific offline group 101. In this example, the information related to the plurality of users 102-1 to 102-4 may include a name, a phone number, an e-mail address, or a message application ID of each of the plurality of users 102-1 to 102-4.

Meanwhile, in a case in which the plurality of users 102-1 to 102-4 each joins a specific online group 101, the client bot 103 set for the specific group 101 may be registered as a friend of the plurality of users 102-1 to 102-4 based on information related to the plurality of users 102-1 to 102-4 registered in the specific online group 101 or information related to the specific group 101.

Further, being manually set as a friend refers to a case in which the plurality of users 102-1 to 102-4 installing the message application separately adds the client bot 103 as a friend by searching for the client bot 103 by inputting information related to the client bot 103 (ex. a name, an identification number, etc.), or searching for and selecting the client bot 103 to be registered as a friend from a plurality of already registered friends through scrolling. For example, when the user 102-1 joining the specific group 101 installs the message application, and adds, as a friend, the client bot 103 registered as a virtual friend or using an official account by searching for or selecting the client bot 103 in the message application, the user 102-1 and the client bot 103 may be set as friends.

The plurality of users 102-1 to 102-4 may acquire the group data related to the specific group 101 or the group data generated by the specific group 101 by chatting with the client bot 103 through the chat service provided in various applications (ex. a messaging application, an SNS application, etc.) or sites using the client bot 103 set as a friend.

For this, the client bot 103 needs to be a participant in the chat room of the plurality of users 102-1 to 102-4 joining the specific group 101.

The client bot 103 may participate in the chat room in various manners as described below.

(i) A chat room may be created when the users 102-1 to 102-4 joining the specific group 101 designate the client bot 103 as a chat user.

(ii) When the users 102-1 to 102-4 joining the specific group 101 create a chat room, the client bot 103 may automatically participate in the chat room. In this example, since only the users 102-1 to 102-4 joining the specific group 101 participate in the chat room, the client bot 103 may be displayed to all of the users 102-1 to 102-4 participating in the chat room. If a user not joining the specific group 101 participates in the chat room in addition to the users 102-1 to 102-4 joining the specific group 101, the client bot 103 may be displayed only to the users 102-1 to 102-4 participating in the chat room.

For example, although the user 102-1 joining the specific group 101 does not designate the client bot 103 as a chat user, the client bot 103 may participate in the chat room by default when the user not joining the specific group 101 designates the user 102-2 joining the specific group 101 as a chat user.

In another example, although the user 102-1 joining the specific group 101 does not designate the client bot 103 as a chat user, the client bot 103 may participate in the chat room by default when the chat room is created.

Hence, in a case in which at least one of the users 102-1 to 102-4 joining the specific group 101 participates in the chat room, the client bot 103 may participate in the chat room by default.

(iii) The user 102-1 joining the specific group 101 may invite the client bot 103 after creating a chat room to chat with the user 102-2 joining the specific group 101 or an ordinary user not joining the specific group 101.

In a case in which the client bot 103 participates in the chat room, the client bot 103 may answer unidirectionally only when the users 102-1 to 102-4 joining the specific group 101 and participating in the chat room transfer input data to the client bot 103 to request the group data related to the specific group 101.

That is, the client bot 103 may display the group data related to the specific group 101 corresponding to the input data only when the users 102-1 to 102-4 participating in the chat room inquire through the input data. Thus, although a single user and the client bot 103 participate in the chat room, the corresponding chat room refers to a chat room in which the single user solely participates, rather than a 1:1 chat room. Similarly, although two users and the client bot 103 participate in the chat room, the corresponding chat room refers to a 1:1 chat room rather than a group chat room. That is, only when at least three participants participate in the chat room, the corresponding chat room may be regarded as a group chat room.

When the client bot 103 participates in the chat room, a participant creating the chat room and other participants in the chat room may acquire the group data related to the specific group 101 using the client bot 103. However, a participant allowed to acquire the group data may be limited to the users 102-1 to 102-4 joining the specific group 101. Meanwhile, a participant not joining the specific group 101 may acquire the group data related to the specific group 101 using the client bot 103 participating in the chat room only when satisfying a specific requirement (a policy of the specific group 101, an approval of the participant creating the chat room, or an input of authentication group data).

The client bot 103 formally seems to participate in the chat room. However, the client bot 103 may answer unidirectionally only when the participants in the chat room practically request the group data related to the specific group 101 from the client bot 103. For the participants in the chat room to inquire of the client bot 103, an identifier and the client bot 103 may be input (ex. @bot, !bot) such that the inquiry may be distinct from inquiries made to the other participants.

The plurality of users 102-1 to 102-4 may acquire group data such as the group data related to the specific group 101 or the group data generated by the specific group 101 based on the input data in the chat room in which the client bot 103 participates. The input data may include an instruction and a keyword. The instruction may express the same meaning using at least one word to acquire the group data. For example, in a case of searching for the group data, the instruction included in the input data may be “ [symbol] ”, “find”, or “search”. The keyword may be used to specify group data to be directly acquired based on the instruction. For example, in a case in which the input data is “search+ID”, the client bot 103 may search for a user corresponding to the ID among a plurality of users joining the specific group 101, and provide information related to a found user as the group data.

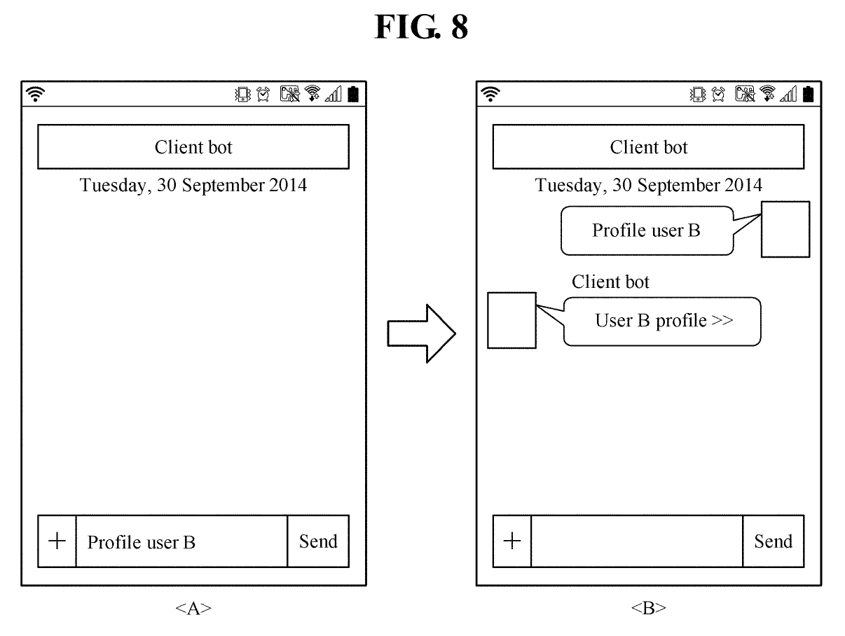

The client bot 103 may search the group DB 104 for the group data requested by the plurality of users 102-1 to 102-4 using the instruction and the keyword constituting the input data input by the plurality of users 102-1 to 102-4, and provide the group data to the plurality of users 102-1 to 102-4, which will be described further in detail with reference to FIGS. 8 through 17.

First of all, the method of providing a chat service according to an embodiment differs from an existing search method in that the client bot 103 may search for group data suitable for chat content corresponding to the input data when the plurality of users 102-1 to 102-4 inputs the chat content (a combination of the instruction and the keyword) into the chat room in which the client bot 103 participates. In this manner, group data desired by the plurality of users 102-1 to 102-4 belonging to the specific group 101 may be transferred more conveniently and accurately.

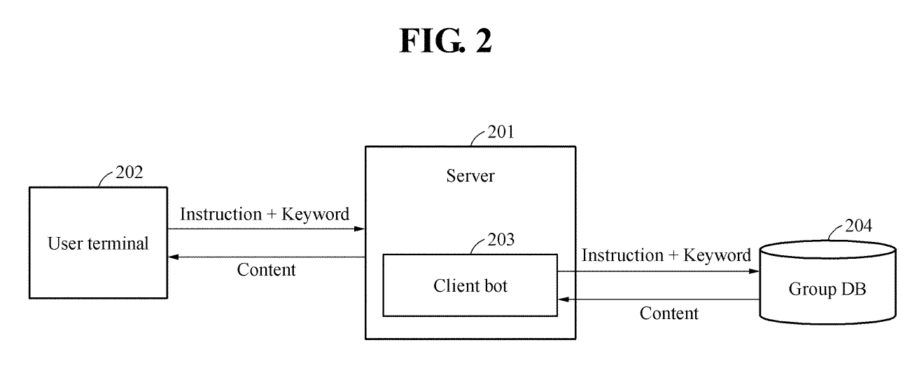

FIG. 2 is a diagram illustrating a method of providing a chat service using a client bot according to an embodiment.

Referring to FIG. 2, a user terminal 202 may transfer an instruction and a keyword to a server 201. Here, the user terminal 202 may correspond to one of the plurality of users 102-1 to 102-4 of FIG. 1. The user terminal 202 joining the specific group 101 may access the server 201 through a message application for a chat service.

First of all, in a case in which the user terminal 202 joins/enrolls for a chat service provided by the server 201, or installs the message application for the chat service, a client bot 203 may be registered as a virtual friend of the user terminal 202. The client bot 203 of the specific group 101 may be registered as a virtual friend of the user terminal 202 joining the specific group 101.

In an example, when the user terminal 202 joining the specific group 101 installs the message application, the client bot 203 of the specific group 101 may be automatically added as a friend of the user terminal 202. In another example, through a separate friend adding process, the user terminal 202 may register the client bot 203 of the specific group 101 as a friend in the message application. The client bot 203 may be a type of virtual friend configured to provide content corresponding to input data as an answer only when the input data is input into a chat room to acquire content related to a specific group, rather than a real friend to exchange chat content with.

Meanwhile, the user terminal 202 may create a chat room in which the client bot 203 is to participate to acquire group data related to the specific group 101 through the client bot 203. When the user terminal 202 joining the specific group 101 creates a chat room, the client bot 203 of the specific group 101 may automatically participate in the chat room in response to the creation of the chat room. In another example, after the chat room is created, the user terminal 202 may request the client bot 203 to participate in the chat room.

The user terminal 202 may transfer input data including an instruction and a keyword to the client bot 203 participating in the chat room, and acquire content related to the specific group corresponding to the instruction and the keyword through the client bot 203.

In the example of FIG. 2, the user terminal 202 may input, as the input data, chat content generated by combining the instruction and the keyword through the chat room in which the client bot 203 participates. The client bot 203 may search a group DB 204 based on the instruction and the keyword constituting the chat content corresponding to the input data, and extract content which is group data matching the instruction and the keyword.

The client bot 203 may incorporate the content in a message to respond to the chat content input by the user terminal 202 in the chat room and transfer the message to the user terminal 202. In practice, the message application of the user terminal 202 may provide an interface for the user terminal 202 and the client bot 203 to perform a chat while exchanging messages through the chat room.

In this example, the instruction refers to a search keyword that the user terminal 202 desires to process with respect to the content matching the keyword. For example, in a case in which the instruction is “find” and the keyword is “user ID”, the client bot 203 may search for a user corresponding to the user ID and provide the user terminal 202 with personal group data (a profile) of the user as content. Here, the keyword may correspond to organization group data of the specific group related to the client bot 203, group data related to a group member belonging to the specific group, neighborhood group data of the specific group, or item group data of the specific group.

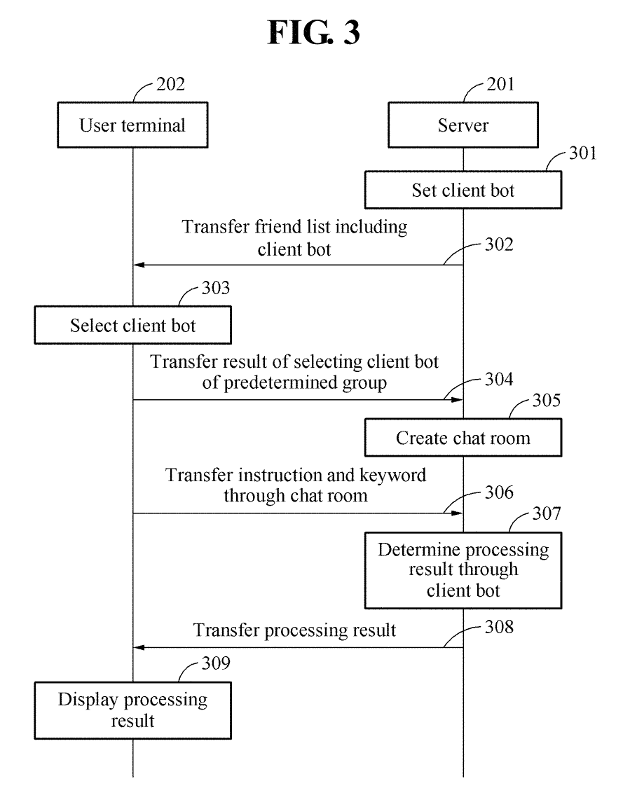

FIG. 3 is a flowchart illustrating a method of providing a chat service according to an embodiment.

In operation 301, the server 201 may set the client bot 203. In this example, the client bot 203 may refer to a type of virtual friend configured to provide the user terminal 202 with group data related to a specific group that the user terminal 202 joins through a chat room. When the user terminal 202 joins the specific group, the client bot 203 may be manually or automatically set as a friend of the user terminal 202. The description provided with reference to FIG. 1 may apply thereto.

In operation 302, the server 201 may transfer a friend list including the client bot 203 to the user terminal 202.

In operation 303, the user terminal 202 may select the client bot 203 to create a chat room in which the client bot 203 is to participate.

In operation 304, the user terminal 202 may transfer a result of selecting the client bot 203 of the specific group to the server 201. In operation 305, the server 201 may create the chat room in which the client bot 203 is to participate.

In another example, when the user terminal 202 selects a group member belonging to the specific group, rather than directly selecting the client bot 203, the client bot 203 may automatically participate in a chat room in which the group member participates. In still another example, the user terminal 202 may create a chat room by selecting a group member other than the client bot 203 or a user other than the group member, and invite the client bot 203 to the corresponding chat room.

In operation 306, the user terminal 202 may transfer input data including an instruction and a keyword to the server 201 through the chat room. In operation 307, the server 201 may determine group data corresponding to the input data through the client bot 203. In detail, the client bot 203 of the specific group may determine the group data by determining content related to the specific group based on the input data. Here, the group data may include data generated by the specific group, group data related to a group member belonging to the specific group, group data related to the specific group, neighborhood group data of the specific group, and an invitation to a group member belonging to the specific group.

In operation 308, the server 201 may transfer the group data corresponding to the input data to the user terminal 202. In operation 309, the user terminal 202 may display the group data corresponding to the input data in the chat room.

Thus, to acquire desired content related to the specific group, the user terminal 202 may transfer the input data including the instruction and the keyword as a message in a form of a chat with the client bot 203 participating in the chat room. The client bot 203 may transfer group data corresponding to the input data to the user terminal 202 as an answer message with respect to the corresponding message. Here, the answer message may include the desired content related to the specific group.

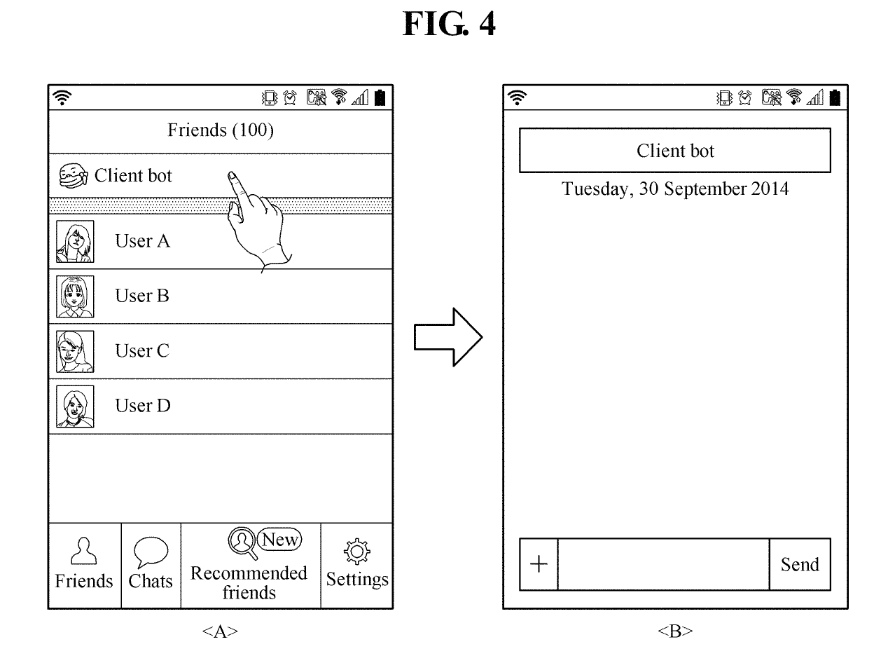

FIG. 4 is a diagram illustrating a chat window to perform a chat with a client bot selected in a friend list according to an embodiment.

<A> in FIG. 4 illustrates a process of selecting the client bot 203 included in a friend list after a message application is executed in the user terminal 202. The client bot 203 refers to a virtual friend automatically included in the friend list when the user terminal 202 joins a specific group.

Each time the user terminal 202 joins the specific group, the client bot 203 of the specific group may be included in the friend list. For example, when the user terminal 202 joins a specific group, a managing server that manages the corresponding group may transfer personal group data (ID group data when joining a messenger service) input by the user terminal 202 to the server 201. The server 201 may transfer group data related to the client bot 203 of the specific group to the user terminal 202.

<B> in FIG. 4 illustrates an example of displaying a chat window corresponding to a chat room in which the client bot 203 participates on the user terminal 202 when the client bot 203 is selected in the user terminal 202. That is, the client bot 203 may also be a chat user of the user terminal 202 similar to a general friend. Thus, a chat room in which the user terminal 202 may transfer chat content to the client bot 203 may be created, and the chat window may be displayed through the message application. The user terminal 202 may receive an input of the chat content including an instruction and a keyword through a message input window displayed in a specific region of the chat window.

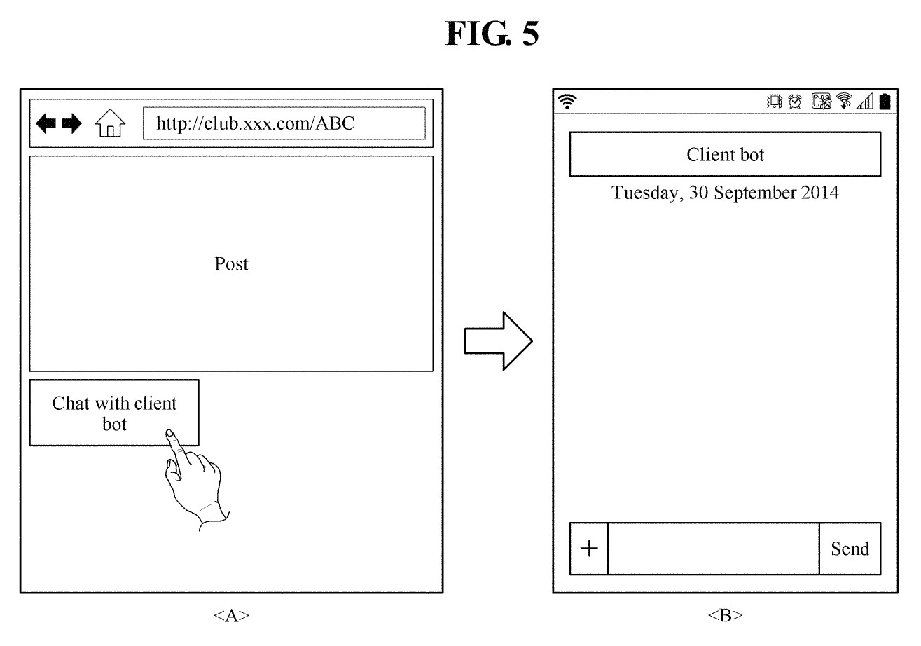

FIG. 5 is a diagram illustrating a chat window to perform a chat with a client bot through a menu provided on a page of a specific group according to an embodiment.

<A> in FIG. 5 illustrates a process in which the user terminal 202 accesses a web page of a specific group and selects an icon displayed on the web page. When the icon is selected, the user terminal 202 may execute a message application to chat with the client bot 203 of the specific group. As shown in <B> of FIG. 5, a chat room in which the client bot 203 participates as a chat user may be created, and a chat window of the chat room may be displayed through a chat window of the message application executed in the user terminal 202.

That is, in the example of FIG. 5, by selecting an identifier (an icon, a menu, a button, etc.) provided on the page of the specific group related to the client bot 203, rather than selecting the client bot 203 in the friend list, the user terminal 202 may automatically execute the message application and enter the chat room at the same time to directly chat with the client bot 203.

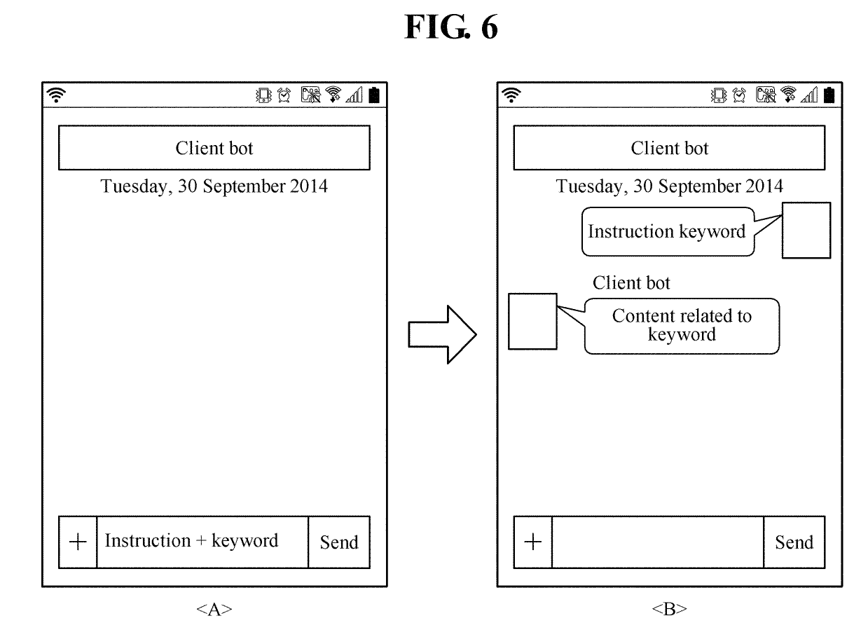

FIG. 6 is a diagram illustrating a process of providing content related to a keyword in response to an input of a message generated by combining an instruction and the keyword according to an embodiment.

Referring to <A> in FIG. 6, a chat window corresponding to a chat room may be displayed through a message application executed in the user terminal 202. The user terminal 202 may receive chat content including an instruction and a keyword input by a user through a message input window.

As shown in <B> in FIG. 6, the chat content including the instruction and the keyword, and chat content including content related to a specific group extracted by the client bot 203 based on the instruction and the keyword may be displayed in a chat history. Here, the content related to the specific group may be found in the group DB 204 of the specific group based on the instruction and the keyword.

If the user terminal 202 continuously inputs the instruction and the keyword through the chat window of <A> in FIG. 6, the chat content input by the user terminal 202 and content corresponding to the chat content may be continuously displayed in the chat history unless the user terminal 202 leaves the chat room.

However, it may be difficult for the user of the user terminal 202 to memorize all instructions supported by the client bot 203. Thus, the user terminal 202 may provide types of instructions and description of the instructions through a separate menu or a page of the message application. In a case in which the user inputs a preset symbol such as “?” or character through the chat window of <A> in FIG. 6, the types of instructions and the description of the instructions may be displayed in a form of an answer provided by the client bot 203.

Hence, in the example of FIG. 6, the user terminal 202 may conveniently acquire content of the specific group related to the client bot 203 by performing a simple chat with the client bot 203.

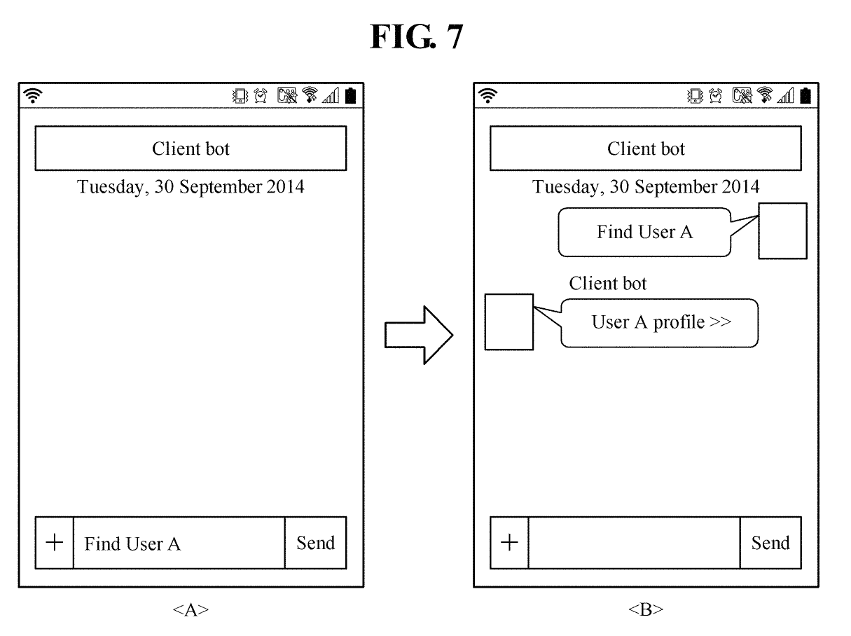

FIG. 7 is a diagram illustrating an example of acquiring personal group data of a group member of a specific group according to an embodiment.

Referring to <A> in FIG. 7, it is assumed that the user terminal 202 receives an instruction “Find” and a keyword “user A” input through a chat window displayed in a message application. Here, “Find” may be an instruction to provide group data related to a profile corresponding to the input keyword. In another example, “Find” may be an instruction to verify whether a user corresponding to the keyword joins or belongs to a specific group. In this example, the keyword input together with “Find” may be a user belonging to a specific group, a team of the specific group that the user belongs to, or a club that the user belongs to.

That is, in a case in which “Find user A” is input through the chat window as shown in <A> of FIG. 7, an answer message including group data related to a profile corresponding to the user A may be displayed on the chat window as shown in <B> of FIG. 7. The answer message may be generated in response to the client bot 203 searching the group DB 204 using a combination of the instruction and the keyword. Here, the group data related to the profile may include a link to access a page displaying a profile set by the user A.

Unlike the example of FIG. 7, the instruction “find” may be an instruction to acquire item group data related to a specific group. Group data related to an item (ex. an item name, an item attribute, etc.) may be input as a keyword with respect to the instruction. For example, it is assumed that the specific group is a secondhand site that sells a plurality of items, and the user of the user terminal 202 inputs “find item A”. The client bot 203 may display, through the chat window, price group data of the item A, description group data of the item A, and seller group data of the item A based on group data related to the item A which is the keyword input by the user of the user terminal 202 in a group DB 204 related to the secondhand site.

FIG. 8 is a diagram illustrating another example of acquiring personal group data of a group member of a specific group according to an embodiment.

Referring to <A> in FIG. 8, it is assumed that the user terminal 202 receives an instruction “profile” and a keyword “user B” input through a chat window displayed in a message application. Here, “profile” may be an instruction to provide group data related to a profile corresponding to the input keyword. In this example, the keyword input together with the instruction “profile” may be a user belonging to a specific group, a team of the specific group that the user belongs to, or a club that the user belongs to. That is, in a case in which “profile user B” is input through the chat window as shown in <A> of FIG. 8, an answer message including group data related to a profile corresponding to the user B may be displayed on the chat window as shown in <B> of FIG. 8. The answer message may be generated in response to the client bot 203 searching the group DB 204 using a combination of the instruction and the keyword. Here, the group data related to the profile may include a link to access a page displaying a profile set by the user B.

In the example of FIG. 8, a plurality of instructions having the same meaning or similar meaning may be set. The instructions may be set using words having the same meaning or similar meanings with respect to a specific search keyword. For example, as a meaning of instructing the client bot 203 to search for group data corresponding to the keyword, one of instructions such as “profile, search, and discover” may be input. In another example, the instructions may be set using different languages that express a specific term. For example, as a meaning of instructing the client bot 203 to search for group data corresponding to the keyword, one of instructions such as “ [symbol] , profile, find, and [symbol] ” may be input.

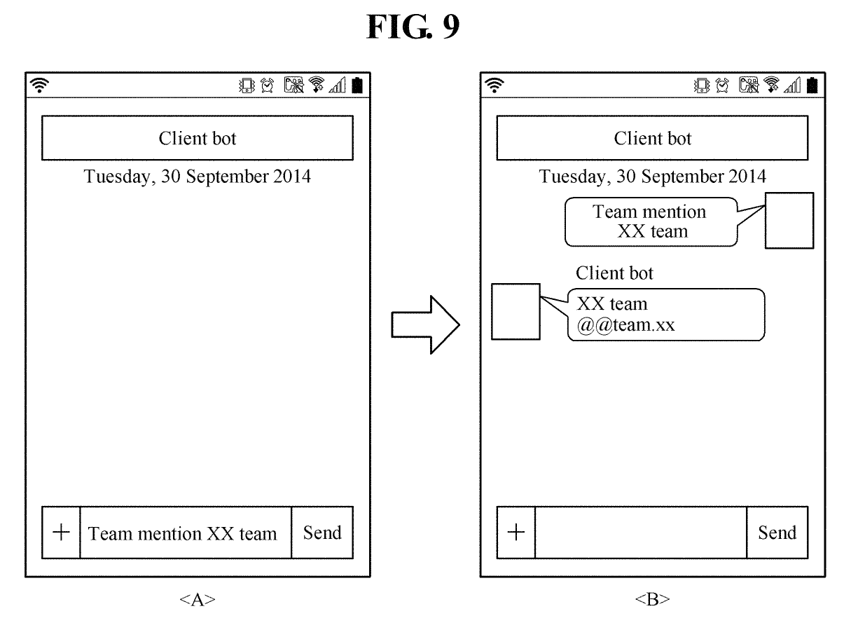

FIG. 9 is a diagram illustrating an example of acquiring group group data related to a specific group according to an embodiment.

Referring to <A> in FIG. 9, it is assumed that the user terminal 202 receives an instruction “team mention” and a keyword “XX team” corresponding to a team name input through a chat window displayed in a message application. Here, “team mention” may be an instruction to provide group data related to a team corresponding to the input keyword. In this example, the keyword input together with the instruction “team mention” may be a team of a specific group that a user belongs to, or a club that the user belongs to.

As shown in <B> of FIG. 9, a team ID “@@team.XX” of the XX team may be displayed as an answer message on the chat window based on the instruction and the keyword input using the user terminal 202. Here, the team ID may be an ID of a team that the user desires to find in an application (an application related to SNS) other than the message application. That is, the user may input the team ID through the corresponding application, thereby immediately accessing a page corresponding to the team ID.

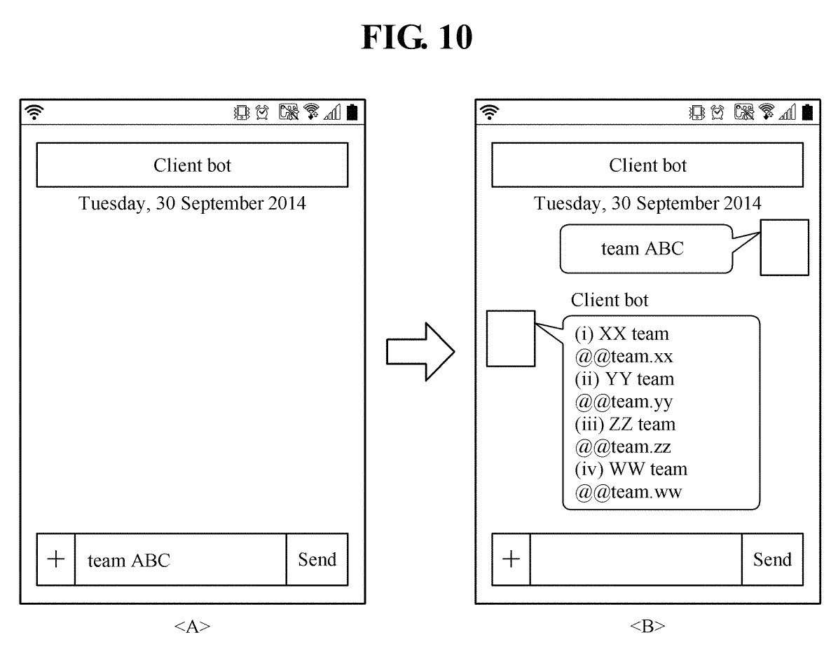

FIG. 10 is a diagram illustrating another example of acquiring group group data related to a specific group according to an embodiment.

Referring to <A> in FIG. 10, it is assumed that the user terminal 202 receives an instruction “team” and a keyword “ABC” corresponding to a group name of a specific group input through a chat window displayed in a message application. Here, “team” may be an instruction to provide group data related to the group corresponding to the input keyword. In this example, the keyword input together with the instruction “team” may be a specific group that the user belongs to.

As shown in <B> of FIG. 10, team IDs of a plurality of teams constituting the ABC group may be displayed as an answer message on the chat window based on the instruction and the keyword input using the user terminal 202. Here, a team ID may be an ID of a team that the user desires to find in an application (an application related to SNS) other than the message application. That is, the user may input the team ID through the corresponding application, thereby immediately accessing a page corresponding to the team ID.

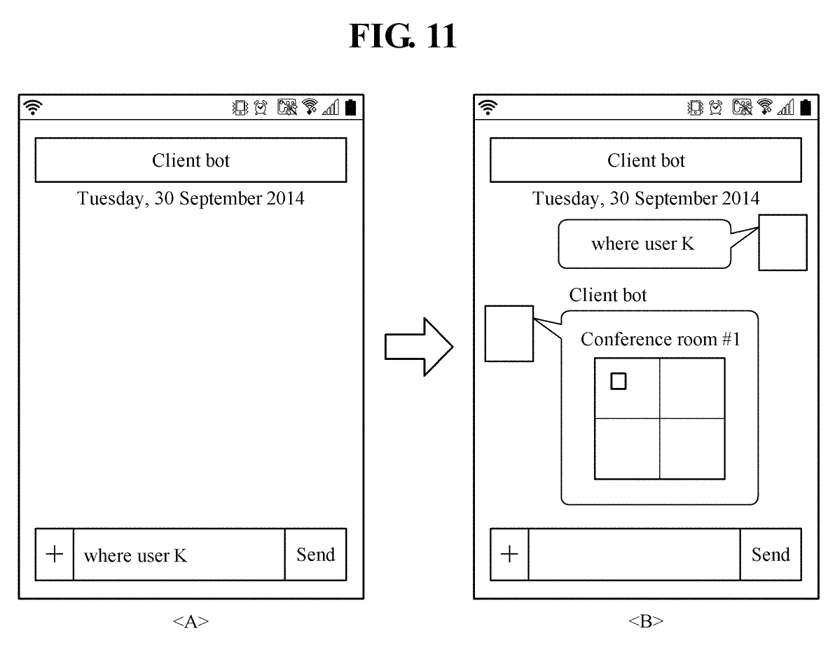

FIG. 11 is a diagram illustrating an example of indicating a position of a group member of a specific group according to an embodiment.

Referring to <A> in FIG. 11, it is assumed that the user terminal 202 receives an instruction “where” and a keyword “user K” corresponding to a user name or a user ID input through a chat window displayed in a message application. Here, “where” may be an instruction to indicate a position of a user corresponding to the input keyword. In this example, the keyword input together with the instruction “where” may be a place related to a specific group, group data (ex. a user name, or a user ID) related to a user belongs to the specific group, or group data (ex. a team name, or a team ID) related to a team of the specific group.

As shown in <B> of FIG. 11, an answer message indicating a position of the user corresponding to the keyword in a building related to the specific group may be displayed on the chat window based on the instruction and the keyword input using the user terminal 202. Here, conference room #1 may refer to a specific position of the user corresponding to the keyword in the specific building. In this example, by mapping the specific position on a map related to the specific building in the answer message, the user of the user terminal 202 may determine a position of the place more intuitively.

In an example, the position of the user may be determined based on internet protocol (IP) group data assigned through a wire network or a location of a wireless-fidelity (WiFi) access point that the user is connected, or image group data acquired by capturing a specific place.

In a case in which the keyword is a specific place in a specific group in the example of <A> in FIG. 11, a map on which the specific place is mapped may be displayed together with description of a position of the specific place in the specific group in the answer message.

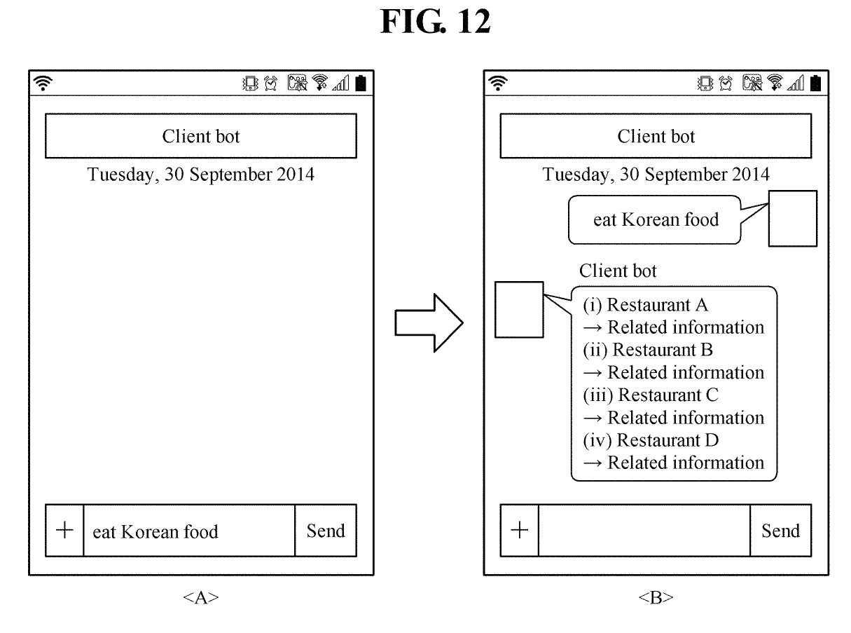

FIG. 12 is a diagram illustrating an example of displaying neighborhood group data of a specific group according to an embodiment.

Referring to <A> in FIG. 12, it is assumed that the user terminal 202 receives an instruction “eat” and a keyword “Korean food” corresponding to a food category input through a chat window displayed in a message application. Here, “eat” may be an instruction to provide group data (ex. a name, a position, a menu, working hours, etc.) related to a store corresponding to the input keyword. In this example, the position of the store may be a position of the store inside or outside a place related to a specific group. The keyword input together with the instruction “eat” may be a food category or a menu.

As shown in <B> of FIG. 12, an answer message including group data related to the store corresponding to the keyword may be displayed on the chat window based on the instruction and the keyword input using the user terminal 202. Here, the related group data may include a position, a name, a phone member, a position, working hours, a menu, and a uniform resource locator (URL) for reservation of a restaurant related to the keyword. In this example, the position of the restaurant may be displayed by being mapped on a map showing an inside or an outside of the place related to the specific group.

Meanwhile, restaurants included in a restaurant list may be displayed by being arranged based on a criterion such as a degree of relation to the keyword, a distance from a user terminal used to input the instruction and the keyword, or a number of available seats.

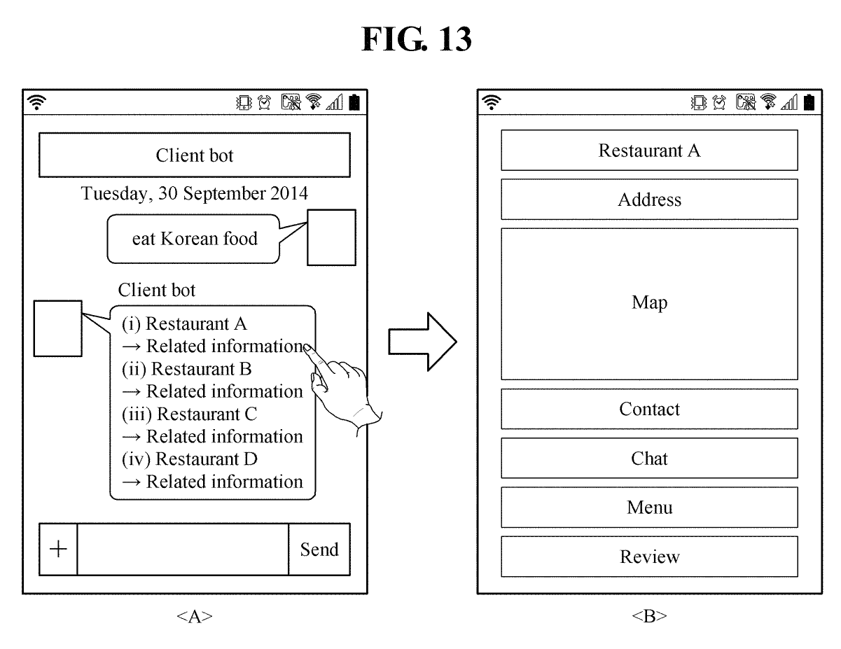

FIG. 13 is a diagram illustrating an example of displaying detailed related group data through neighborhood group data of a specific group according to an embodiment.

Referring to <A> in FIG. 13, an example in which the user selects group data related to “restaurant A” in the answer message of <B> in FIG. 12 is illustrated. As shown in <B> of FIG. 13, group data related to the restaurant A may be displayed in detail on a page related to the restaurant A. As shown in <B> of FIG. 13, the group data related to the restaurant A may include an address of the restaurant A, a map on which a position thereof is mapped, contact information, a chat through a message application, a menu, and reviews.

That is, in a case in which the group data processed by the client bot 203 based on the instruction and the keyword input using the user terminal 202 is displayed on the chat window, the user terminal 202 may provide detailed group data of the group data through a separate page distinct from the chat window in response to the user selecting the group data.

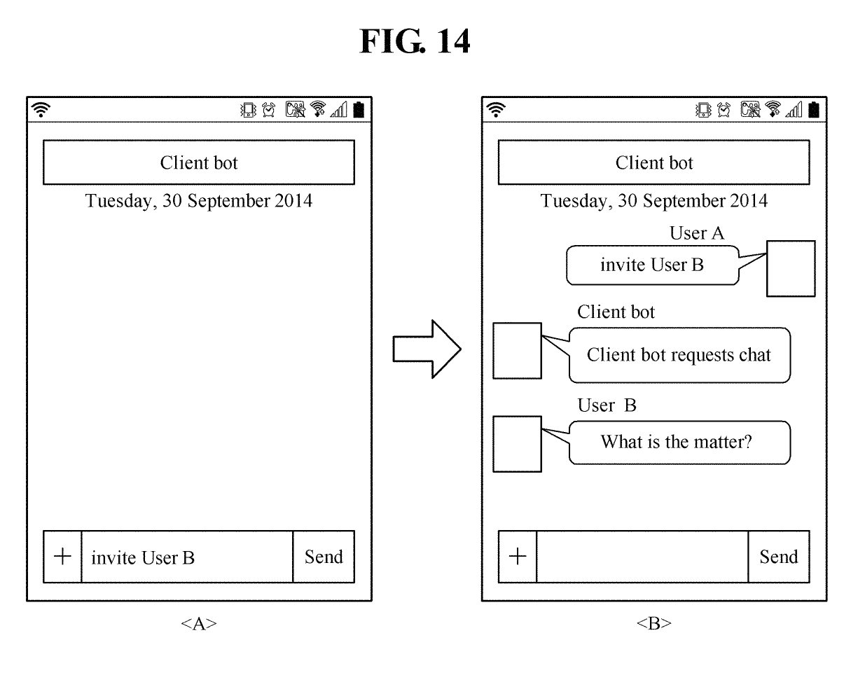

FIG. 14 is a diagram illustrating an example of inviting a group member of a specific group as a chat user according to an embodiment.

FIGS. 14 through 16 are diagrams illustrating examples in which the user of the user terminal 202 directly chats with a group member of a specific group by inviting the group member of the specific group as a chat user through the client bot 203.

Referring to <A> in FIG. 14, it is assumed that the user terminal 202 receives an instruction “invite” and a keyword “user B” corresponding to a user name or a user ID input through a chat window displayed in a message application. Here, “invite” may be an instruction to enable a user corresponding to the keyword to enter a chat room and chat with the user of the user terminal 202.

In this example, the keyword input together with the instruction “invite” may be group data (ex. a user name, or a user ID) related to a user belonging to a specific group, or group data (ex. a team name, or a team ID) related to a team of the specific group. In a case in which a plurality of keywords corresponding to group data related to users is provided, the user of the user terminal 202 may perform a group chat with a plurality of users set as chat users. Further, in a case in which the keyword is group data related to a team, the user of the user terminal 202 may perform a group chat with group members belonging to the team.

Referring to <B> in FIG. 14, the user B invited by the user A of the user terminal 202 may enter the chat room. Here, while the user A and the client bot 203 are participating in the chat room, the user B invited by the user A may enter the chat room.

FIG. 14 illustrates a process of performing a chat with the chat user invited by the user of the user terminal 202 through the chat room in which the client bot 203 participates. In this example, although the chat user enters the chat room, the client bot 203 may maintain a state of participating in the chat room like a participant in a group chat, rather than leaving the chat room.

The user of the user terminal 202 participating in the chat room, and the chat user invited to the chat room may input an instruction and a keyword through the client bot 203 participating in the chat room, as in the examples of FIGS. 6 through 13. The user of the user terminal 202 and the chat user invited to the chat room may acquire group data related to a desired specific group through a chat window corresponding to the chat room using the client bot 203.

In particular, although the user A and the user B are not friends on a message application in the example of FIG. 14, the user A may invite the user B to the chat room as a chat user through the client bot 203 in a case in which the user A and the user B join a specific group. That is, the user A may conveniently invite the user B to the chat room by simply inputting an instruction “invite” and a keyword “user B”, without separately adding the user B as a friend.

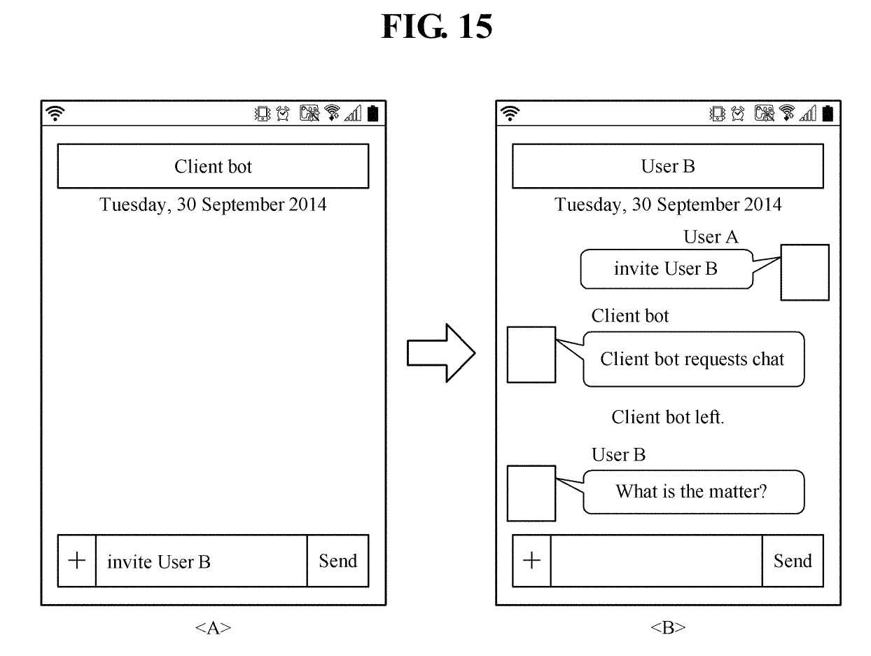

FIG. 15 is a diagram illustrating another example of inviting a group member of a specific group as a chat user according to an embodiment.

Referring to <A> in FIG. 15, it is assumed that the user terminal 202 receives an instruction “invite” and a keyword “user B” corresponding to a user name or a user ID input through a chat window displayed in a message application. Here, “invite” may be an instruction to enable a user corresponding to the input keyword to enter a chat room and chat with the user of the user terminal 202.

In this example, the keyword input together with the instruction “invite” may be group data (ex. a user name, or a user ID) related to a user belonging to a specific group, or group data (ex. a team name, or a team ID) related to a team of the specific group. In a case in which a plurality of keywords corresponding to group data related to users is provided, the user of the user terminal 202 may perform a group chat with a plurality of users set as chat users. Further, in a case in which the keyword is group data related to a team, the user of the user terminal 202 may perform a group chat with group members belonging to the team.

Referring to <B> in FIG. 15, a chat room in which the user A of the user terminal 202 and the user B invited by the user A are to participate may be created. Here, while the user A and the user B are participating in the chat room, the client bot 203 may leave the chat room in reality after being involved in the creation of the chat room.

In the example of FIG. 15, a new chat room in which the user A and the user B are to participate, rather than the chat room in which the client bot 203 participates, may be created. In this example, when the user B being a chat user enters the chat room, the client bot 203 may leave the chat room. Meanwhile, the existing chat room in which the client bot 203 and the user A participate may be maintained or removed.

The user A and the user B may invite the client bot 203 to the chat room using an instruction “invite” and a keyword “client bot”. The user of the user terminal 202 participating in the chat room, and the chat user invited to the chat room may input an instruction and a keyword through the client bot 203 participating in the chat room, as in the examples of FIGS. 7 through 13. The user of the user terminal 202 and the chat user invited to the chat room may acquire group data related to a desired specific group through a chat window corresponding to the chat room using the client bot 203.

Although the user A and the user B are not friends on a message application in the example of FIG. 15, the user A may invite the user B to the chat room as a chat user through the client bot 203 in a case in which the user A and the user B join a specific group. That is, the user A may conveniently invite the user B to the chat room by simply inputting an instruction “invite” and a keyword “user B”, without separately adding the user B as a friend.

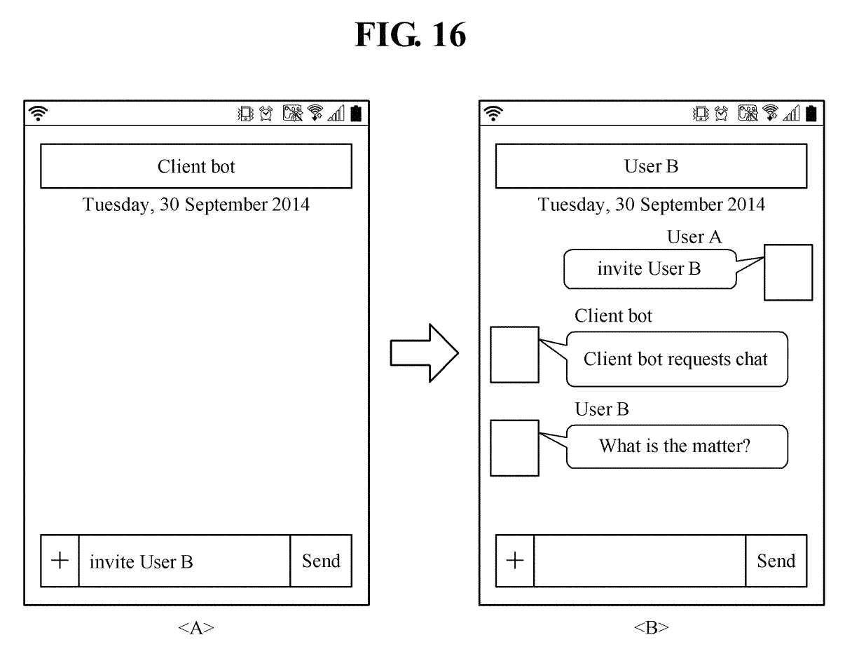

FIG. 16 is a diagram illustrating still another example of inviting a group member of a specific group as a chat user according to an embodiment.

Referring to <A> in FIG. 16, it is assumed that the user terminal 202 receives an instruction “invite” and a keyword “user B” corresponding to a user name or a user ID input through a chat window displayed in a message application. Here, “invite” may be an instruction to enable a user corresponding to the input keyword to enter a chat room and chat with the user of the user terminal 202.

In this example, the keyword input together with the instruction “invite” may be group data (ex. a user name, or a user ID) related to a user belonging to a specific group, or group data (ex. a team name, or a team ID) related to a team of the specific group. In a case in which a plurality of keywords corresponding to group data related to users is provided, the user of the user terminal 202 may perform a group chat with a plurality of users set as chat users. Further, in a case in which the keyword is group data related to a team, the user of the user terminal 202 may perform a group chat with group members belonging to the team.

Referring to <B> in FIG. 16, a chat room in which the user A of the user terminal 202 and the user B invited by the user A are to participate may be created. Here, the user A and the user B are participating in the chat room. In this example, the client bot 203 may continuously participate in the chat room after being involved in the creation of the chat room, unlike the example of FIG. 15. Meanwhile, the existing chat room in which the client bot 203 and the user A participate may be maintained or removed.

In the example of FIG. 16, a new chat room in which the user A and the user B are to participate, rather than the chat room in which the client bot 203 participates, may be created. In this example, although the user B being the chat user enters the chat room, the client bot 203 may stay in the chat room as a part of the participants, rather than leaving the chat room.

The user of the user terminal 202 participating in the chat room, and the chat user invited to the chat room may input an instruction and a keyword through the client bot 203 participating in the chat room, as in the examples of FIGS. 8 through 14. The user of the user terminal 202 and the chat user invited to the chat room may acquire group data related to a desired specific group through a chat window corresponding to the chat room using the client bot 203.

Although the user A and the user B are not friends on a message application in the example of FIG. 16, the user A may invite the user B to the chat room as a chat user through the client bot 203 in a case in which the user A and the user B join a specific group. That is, the user A may conveniently invite the user B to the chat room by simply inputting an instruction “invite” and a keyword “user B”, without separately adding the user B as a friend.

That is, the examples of FIGS. 14 through 16 may be summarized as below.

In the example of FIG. 14, the user of the user terminal 202 may input an instruction “invite” and a keyword corresponding to group data related to a group member of a specific group by setting the group member as a chat user. The invited group member may enter the chat room in which the user of the user terminal 202 and the client bot 203 are participating. A chat may be performed between the user of the user terminal 202 and the group member invited to the chat room. In this example, the client bot 203 may stay in the chat room, rather than leaving the chat room.

In the example of FIG. 15, the user of the user terminal 202 may input an instruction “invite” and a keyword corresponding to group data related to a group member of a specific group by setting the group member as a chat user. A new chat room in which the user of the user terminal 202 and the group member are to participate, rather than the chat room in which the user of the user terminal 202 and the client bot 203 are participating, may be created. The client bot 203 may leave the new chat room when the group member participates in the new chat room after being involved in the creation of the new chat room. A chat between the user of the user terminal 202 and the group member invited to the chat room may be performed.

In the example of FIG. 16, the user of the user terminal 202 may input an instruction “invite” and a keyword corresponding to group data related to a group member of a specific group by setting the group member as a chat user. A new chat room in which the user of the user terminal 202 and the group member are to participate, rather than the chat room in which the user of the user terminal 202 and the client bot 203 are participating, may be created. Although the group member participates in the new chat room, the client bot 203 may stay in the new chat room, rather than leaving the chat room after being involved in the creation of the new chatroom. A chat between the user of the user terminal 202 and the group member invited to the chat room may be performed.

Hence, the user of the user terminal 202 may process various content related to a specific group through the client bot 203 set as a virtual friend by joining the specific group. In this example, the user of the user terminal 202 may input an instruction and a keyword in the chat room in which the client bot 203 participates, thereby acquiring group data related to the specific group.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of providing a chat service, the method performed by a user terminal, the method comprising:
transferring input data related to a specific group to a server, the input data input into a chat room in which a client bot related to the specific group participates;
receiving group data corresponding to the input data from the server; and
displaying the received group data in the chat room,
wherein the specific group is formed in the chat service or in an external service of the chat service, and
the server is configured to operate a service related to the specific group and transfer the group data to the user terminal through the client bot.

2. The method of claim 1, wherein the chat room is created when a user of the user terminal selects the client bot, or invites the client bot or a friend of the user terminal.

3. The method of claim 1, further comprising:
determining whether the user terminal joins the specific group when the chat room is created; and
transferring a join request with respect to the specific group when the user terminal does not join the specific group.

4. The method of claim 1, wherein the client bot is automatically or manually set as a friend of the user terminal in response to the user terminal joining the specific group.

5. The method of claim 1, wherein the client bot is set as a friend of the user terminal based on information related to the specific group or information related to the user terminal when the user terminal joins the specific group.

6. The method of claim 1, wherein the client bot is set as a friend of the user terminal when in response to the user terminal selecting a client bot registered as a virtual friend or using an official account when the user terminal joins the specific group.

7. The method of claim 1, wherein the input data comprises an instruction based at least one word to acquire the group data related to the specific group.

8. The method of claim 1, wherein the displaying of the received group data in the chat room comprises displaying organization information or group member information of the specific group related to the client bot.

9. A method of providing a chat service, the method performed by a server, the method comprising:
receiving, from a user terminal, input data input into a chat room in which a client bot of a specific group participates, the user terminal joining the specific group;
acquiring group data related to the specific group that are processed by the client bot based on the input data; and
providing the group data to the user terminal in the chat room.

10. An application stored in a medium in association with hardware configured to perform claim 1.

11. A user terminal, comprising:
an input data transferor configured to transfer, to a server, input data input into a chat room in which a client bot of a specific group participates;
a group data receiver configured to receive, from the server, group data related to the specific group that are processed by the client bot based on the input data; and
a group data display configured to display the received group data in the chat room.
